(19) United States
(12) Patent Application Publication
(10) Pub. No.: US 2015/0178511 A1
(43) Pub. Date: Jun. 25, 2015

(54) METHODS AND SYSTEMS FOR SHARING PSYCHOLOGICAL OR PHYSIOLOGICAL CONDITIONS OF A USER

(71) Applicant: United Video Properties, Inc., Santa Clara, CA (US)

(72) Inventors: Walter R. Klappert, Los Angeles, CA (US); Rodney Gaidies, Highlands Ranch, CO (US); Mark Maslyn, Littleton, CO (US); Robert Brooks, Aurora, CO (US); Timothy Sherwood, Parker, CO (US)

(73) Assignee: UNITED VIDEO PROPERTIES, INC., Santa Clara, CA (US)

(21) Appl. No.: 14/137,552

(22) Filed: Dec. 20, 2013

(51) Int. Cl. G06F 21/62

(52) U.S. Cl. CPC G06F 21/62

(57) ABSTRACT

Methods and systems are disclosed herein for a media guidance application that responds to requests for biometric measurements of a user from various entities by referencing privacy settings associated with the various biometric measurements to determine whether or not to share a particular biometric measurement with each of the entities.

### BACKGROUND

In conventional systems, information regarding a user is often tracked. For example, tracking the viewing habits of a user allows systems to predict what the user wishes to watch without having to question the user directly. Furthermore, tracked information (such as web-sites visited or items purchased) may be used to target particular media, for example, recommended programs or advertisements, to a user. However, as the breadth and scope of what information is tracked increased, privacy concerns have become a pressing issue.

### SUMMARY

Accordingly, methods and systems are disclosed herein for a media guidance application that responds to requests for biometric characteristics of a user from various entities by referencing privacy settings associated with the various biometric measurements to determine whether or not to share a particular biometric measurement with the each of the entities.

For example, the media guidance application may receive one or more user selections associated with particular psychological or physiological conditions (e.g., stress level, mood, etc.). In response, the media guidance application may monitor the user for biometric measurements (e.g., heart rate, blood pressure, alpha wave brain activity, etc.) associated with the psychological or physiological conditions. In addition, the media guidance application may receive requests from other entities (e.g., advertisements, other users, etc.) for the biometric measurements. The media guidance application may compare privacy settings (e.g., established by the user) associated with each of the biometric measurements to privacy settings associated with the entities to determine whether or not one or more of the biometric measurements (or psychological or physiological conditions of the user) may be shared with each entity.

In one aspect, the media guidance application receives a request from an entity for a plurality of biometric measurements of a user, in which the request includes an entity identifier. The media guidance application accesses a privacy setting for a first biometric measurement and a second biometric measurement of the plurality of biometric measurements, in which the privacy setting indicates biometric measurement access permissions associated with different entities. The media guidance application compares the entity identifier to the privacy setting to determine the access permissions associated with the entity for the first biometric measurement and the second biometric measurement. In response to determining the entity has permission to access the first biometric measurement and does not have permission to access the second biometric measurement, the media guidance application shares the first biometric measurement of the user with the entity without sharing the second biometric measurement of the user with the entity.

In some embodiments, the media guidance application may monitor the first biometric measurement of the user and the second biometric measurement of the user in response to a user selection to monitor the first biometric measurement and the second biometric measurement. For example, the media guidance application may generate an interface through which a user may select which biometrics and/or psychological or physiological conditions he/she wishes the media guidance application to monitor. For example, in some embodiments, the media guidance application may not monitor a third biometric measurement of the user in response to a user selection to not monitor the third biometric measurement.

In some embodiments, the media guidance application may receive a media asset targeted to the user based on the plurality of biometric measurements that have been shared with the entity. For example, in response to biometric measurements shared with an entity (e.g., an advertiser), the entity may transmit media (e.g., advertisements) personalized based on the current biometric measurements and/or psychological or physiological conditions of the user.

In some embodiments, the entity may be another user, and the entity identifier may indicate a social network relationship status of that user relative to the user associated with the biometric measurements. For example, the media guidance application may coordinate the sharing of biometric measurements and/or psychological or physiological conditions between users of a social network.

In some embodiments, the media guidance application may share the first biometric measurement of the user by transmitting a data packet indicative of the first biometric measurement of the user. For example, the media guidance application may transmit the data packet indicative of the first biometric measurement of the user over a packet-switched network such as the Internet.

In some embodiments, the request from an entity for the plurality of biometric measurements of the user may be received when the user is within a threshold proximity to the entity. For example, the media guidance application may determine (or receive an indication) that a first user is within a particular geographic area also featuring a second user. Due to the proximity of the first and second user, the media guidance application may communicate various biometric measurements and/or psychological or physiological conditions between users (e.g., whether or not either user is in a happy mood).

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 is an illustrative diagram of a media guidance application managing the sharing of biometric measurements of a user based on privacy settings in accordance with some embodiments of the disclosure;

FIG. 2 is a display screen associated with a media guidance application for use in selecting privacy settings associated with sharing biometric measurements of a user in accordance with some embodiments of the disclosure;

FIG. 3 is a block diagram of an illustrative system used in accordance with some embodiments of the disclosure;

FIG. 4 is an illustrative diagram of a media system in accordance with some embodiments of the disclosure;

FIG. 5 is a flowchart of illustrative steps involved in sharing biometric measurements of a user based on privacy settings in accordance with some embodiments of the disclosure; and

FIG. 6 is a flowchart of illustrative steps involved in providing biometric measurements of a user based on privacy settings in accordance with some embodiments of the disclosure.

### DETAILED DESCRIPTION OF THE DRAWINGS

Methods and systems are disclosed herein for a media guidance application that responds to requests for biometric measurements of a user from various entities by referencing privacy settings associated with the various biometric measurements to determine whether or not to share a particular biometric measurement with each of the entities. For example, a user may allow particular biometric measurements and/or psychological or physiological conditions to be monitored by a media guidance application. However, given the number and variety of entities that may desire to access that information, a user may desire an application that responds to inquires for various biometric measurements and/or psychological or physiological conditions by comparing the entities associated with each request to privacy settings established, maintained, or agreed upon by the user. An application that provides such responses is referred to herein as a media guidance application.

As used herein, “a biometric measurement” refers to distinctive, measurable characteristics used to label and describe the psychological or physiological conditions of a user. For example, biometric measurements that may be received, managed, monitored, and/or shared by a media guidance application may include psychological characteristics related to the emotional state, mood, and/or pattern of behavior of a person, including but not limited to typing rhythm, gait, frequency of social interactions, voice tones, etc., or may include physiological characteristics related to the status and/or shape of the body such as height, weight, medical condition(s), heart rate, blood pressure, fingerprint, body mass index, glucose level, face description, DNA, palm print, hand geometry, iris recognition, retina, odor/scent, and/or any other mechanical, physical, and biochemical functions of a user, his/her organs, and the cells of which they are composed.

In some embodiments, the media guidance application may determine a psychological or physiological condition of a user based on one or more biometric measurements. For example, the media guidance application may determine the current mood of a user based on the heart rate, drowsiness level, or current brain activity of the user. Systems and methods for determining moods and other characteristics of a user based on brain activity are discussed in greater detail in connection with Klappert et al., U.S. patent application Ser. No. 14/038,158, filed Sep. 26, 2013; Klappert et al., U.S. patent application Ser. No. 14/038,046, filed Sep. 26, 2013; Klappert et al., U.S. patent application Ser. No. 14/038,171, filed Sep. 26, 2013; Klappert et al., U.S. patent application Ser. No. 14/038,257, filed Sep. 26, 2013; Klappert et al., U.S. patent application Ser. No. 14/037,984, filed Sep. 26, 2013; and Klappert et al., U.S. patent application Ser. No. 14/038,044, filed Sep. 26, 2013; which are hereby incorporated by reference herein in their entireties.

It should be noted that any embodiment associated with the receipt, management, monitoring, and/or sharing of one or more biometric measurements may also be applied to the receipt, management, monitoring, and/or sharing of one or more psychological or physiological conditions of a user.

In some embodiments, information related to biometric measurements and/or psychological or physiological conditions of a user, including any settings associated with the receipt, management, monitoring, and/or sharing of one or more biometric measurements and/or psychological or physiological conditions of the user may be stored in a user profile. User profiles may also include compilations of media content interests of the user.

Media content interests relate to information on a user, or a group of users, in relation to media content, which may include preferences, actions or decisions related to the performance, distribution, recommendation, creation or consumption (including purchasing) of media content. For example, media content interests may include a user's favorites, likes, dislikes, ratings, critical reviews, or recommendations in regards to a media asset, shows or series currently being watched, shows or series likely to be watched, the time a user typically watches a show or series, or the genre of the show or series typically watched by the user.

Furthermore, a user profile may include demographic information related to a user such as traits regarding the user that indicate a relationship to the performance, distribution, recommendation, creation or consumption of media content, which may be incorporated into the media content interests. For example, a user profile may contain the age, gender, income level, marital status, race and/or ethnicity of the user as any of these traits may suggest a particular media content interest of a user. In addition, the profile may include user viewing histories, market research relating to the user, industry reports relating to the user, surveys, and/or interviews that may suggest particular media content is of interest to a user. This information may be incorporated into the media content interests. For example, an industry report may suggest that, because the user is a particular age, the user is likely to enjoy a particular show, or prefer to share biometric measurements with all users or users of a similar age.

A user profile may also include information about relationships of the user to other users. For example, the user profile may include social networks and social sharing relationships of the user, familial relationships, geographic relationships, and/or demographic relationships, and/or any other professional or social grouping of the user. Furthermore, based on information in a user profile, a media guidance application may infer groupings and/or relationships associated with the user. For example, the media guidance application may determine that, because a home residence of a user is located in a particular area, the user is associated with groups (e.g., a local high school) related to that area.

In some embodiments, the media guidance application may use a social network relationship status of a user relative to an entity to determine whether or not an entity is granted access to biometric measurements of the user. For example, the media guidance application may coordinate the sharing of biometric measurements and/or psychological or physiological conditions between users of a social network based on whether or not the user shares a social network and/or have a particular status in the social network. For example, the media guidance application may share a biometric measurement associated with a “low” privacy setting with entities indicated as “Friends” of a user in the social network. The media guidance application may only share a biometric measurement associated with a “Medium” privacy setting with entities indicated as “Family” of a user in the social network. The media guidance application may only share a biometric measurement associated with a “High” privacy setting with entities indicated as “Girlfriend,” “Boyfriend,” “Wife,” or “Husband” of the user in the social network. In some embodiments, the media guidance application may receive individual user designations as to which entities in a social network may obtain particular biometric measurements, or may establish custom rules for different biometric measurements (e.g., indicating what biometric measurements may be shared with different social network relationship statuses or users).

As referred to herein, a user may be defined as a person or a group. For example, a user may be a single person, or a user may be a group of people. Furthermore, a user may be defined by a device owned/used by the user. For example, some embodiments could be applied to provide a profile of a particular device or devices, used by one or more people.

As used herein, “an entity” is any person, group, organization, unit, or system that may request biometric measurements and/or psychological or physiological conditions associated with a user. An entity may issue a request which indicates what information (e.g., what biometric measurements and/or psychological or physiological conditions, what particular user, what time period or when a measurement and/or condition was made, etc.) the entity is seeking.

In some embodiments, the information (e.g., biometric measurements) shared by the media guidance application needs to be securely regulated especially regarding what information can be shared with whom, and which privacy settings and access permissions need to be considered when a specific entity requests information. To identify the specific entity requesting information, the media guidance application may process an entity identifier associated with the entity. As user herein, “an entity identifier” is any type of indication which identifies the identity of the entity to the media guidance application. For example, the entity's identity may be conveyed in an entity identifier in Application Program Interface (“API”) calls. In another example, the entity identifier may be a serial number received by the media guidance application. The media guidance application may then cross-reference the serial number with a database listing serial numbers associated with entities to determine the particular entity. In another example, the entity identifier may include a file, password, or any other data used by the media guidance application to verify the identity of the entity.

In some embodiments, the media guidance application may receive a request for biometric measurements and/or psychological or physiological conditions of a user based on the proximity of a user to an entity. For example, the media guidance application may only answer a request for biometric measurements for a user, in response, to determining that the user and the entity (e.g., another user) are at the same location. For example, the media guidance application may share the mood of a user (e.g., excited) with any other users at the same location (e.g., a concert) as the user.

As referred to herein, a “threshold proximity” refers to the maximum proximity within which a user may be located from an entity. It should be noted that the threshold proximity is not limited to any particular metric, and a threshold proximity may be defined by any suitable criteria. For example, the threshold proximity may define a particular distance, a particular geographic area, a particular network(s), or any other set of criteria that prospective entities must meet in order to be considered by the media guidance application. Systems and methods for detecting whether a user device is within a threshold proximity or detection region are described in greater detail in Shimy et al. U.S. Patent App. Pub. No. 2011/0069940, filed Sep. 23, 2009, which is hereby incorporated by reference herein in its entirety.

In some embodiments, the media guidance application may even perform actions (e.g., generating recommendations or presenting media assets) based on one or more biometric measurements corresponding to a threshold biometric measurement. For example, in response to detecting that a user has a particular heartbeat rate, the media guidance application alerts an emergency service, generate a media asset on a display device instructing the user to calm down, or performs some other action.

In some embodiments, the media guidance application may compare the entity identified by the entity identifier to privacy settings of the user to determine access permissions granted to the entity. As referred to herein, “a privacy setting” refers to a setting which regulates how, what, when, where, and/or with whom information about a user may be shared with different entities. The privacy setting may indicate general rules related to the sharing of user information that are established, maintained, or agreed upon by the user. In some embodiments, the privacy setting defines what access permissions are granted for each entity. As used herein, “an access permission” refers to an indicator associated with one or more biometric and/or psychological or physiological conditions of a user that indicate to the media guidance application that the one or more biometric and/or psychological or physiological conditions of the user may be shared. For example, a user (e.g., a person) may wish to provide biometric measurements (e.g., a heart rate) to a hospital for monitoring an on-going treatment. Accordingly, the user may adjust his/her privacy settings such that the hospital is given access permissions to his/her heart rate data. The user may adjust his/her privacy settings such that other entities (e.g., an on-line advertiser, a close friend, an employer, etc.) are not given access permissions to his/her heart rate data.

In some embodiments, the media guidance application may use a lookup table to store the various access permissions for each biometric measurements and/or psychological or physiological conditions of the user that is granted to an entity. For example, the media guidance application may filter the access permissions by the entity (e.g., determined by the entity identifier) to determine all the access permissions associated with the entity. The media guidance application may then retrieve the data (e.g., the biometric measurement) associated with each access permission and share the data with the entity.

The access permissions assigned in the lookup table may be generated using user inputs (e.g., selections by a user to share particular data), entity information (e.g., using information about the entity such as whether the entity is a health care organization, government organization, shares a common social network relationship, etc. to determine whether or not to grant an access permission to particular data), historical analysis (e.g., does the user typically share this type of information), profile information (e.g., does the user share this type of information with other entities), or any other suitable means to determine whether to grant an access permission to a particular entity for particular data.

In some embodiments, the media guidance application may use biometric measurements and/or psychological or physiological conditions of a user, or transmit that data for another device or entity to use, to recommend media assets or media content, which may appear on one or more user devices. For example, in response to determining (e.g., based on a perspiration rate) that a user is thirsty, the media guidance application may present an advertisement for a sports drink. Alternatively, the media guidance application may transmit (e.g., based on the privacy settings of the user) information to an advertiser. In response to detecting that the user has an increased perspiration level, the advertiser may present an advertisement for the sports drink.

As referred to herein, the terms “media asset” and “media content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same.

In some embodiments, the media guidance application may be provided as an on-line application (i.e., provided on a website), or as a stand-alone application on a server or as a client on user equipment devices. Various devices and platforms that may implement the media guidance application are described in more detail below. In some embodiments, the media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media card, register memory, processor caches, Random Access Memory (“RAM”), etc.

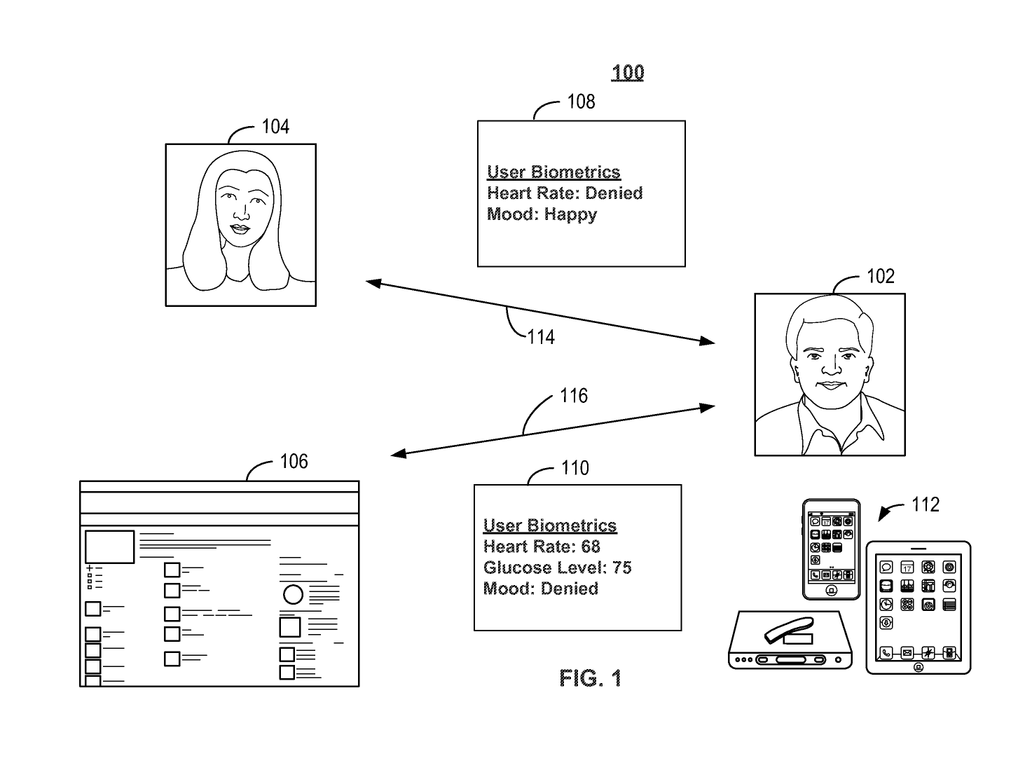

FIG. 1 is an illustrative diagram of a media guidance application managing the sharing of biometric measurements of a user based on privacy settings. FIG. 1 shows diagram 100. In diagram 100, two entities (e.g., entity 104 and entity 106) are receiving biometric measurements (e.g., biometric measurements 108 and biometric measurements 110) of a user (e.g., user 102).

For example, a media guidance application implemented on a user device (e.g., devices 112) may respond to requests for biometric measurements (e.g., biometric measurements 108 and biometric measurements 110) of a user (e.g., user 102) from various entities (e.g., entity 104 and entity 106) by referencing privacy settings associated with the various biometric measurements to determine whether or not to share a particular biometric measurement with each of the entities.

For example, in diagram 100, the media guidance application implemented on one or more of user devices 112 receives a request from entity 104 and entity 106 for a plurality of biometric measurements of user 102. As indicated by line 114 and line 116, various information is shared between the media guidance application and entity 104 (e.g., as indicated by line 114) and entity 106 (e.g., as indicated by line 116). In some embodiments, the media guidance application may share the information by transmitting a data packet indicative of the biometric measurements of the user. For example, the media guidance application implemented on one or more of user devices 112 may transmit a data packet indicative of biometric measurements (e.g., biometric measurements 108) of user 102 over a packet-switched network such as the Internet.

For example, entity 104 may communicate a request for biometric measurements and an entity identifier, which identifies entity 104, to the media guidance application implemented on one or more of user devices 112. Likewise, entity 106 may communicate a request for biometric measurements and an entity identifier, which identifies entity 106, to the media guidance application implemented on one or more of user devices 112.

In some embodiments, an entity may request different information (e.g., different biometric measurements). For example, in diagram 100, entity 104 has requested (e.g., as indicated in biometric measurements 108) a request for heart rate information and mood. In contrast, entity 104 has requested (e.g., as indicated in biometric measurements 110) a request for heart rate information, glucose level information and mood. Alternatively or additionally, an entity (e.g., entity 106) may request all biometric measurements and/or any other user profile information on the user.

In FIG. 1, the media guidance application has accessed privacy settings for the various biometric measurements requested, in which the privacy settings indicate what biometric measurement access permissions associated with different entities. In some embodiments, the privacy settings and access permissions may be stored on one or more of user devices 112 or may be stored remotely and accessed by one or more of user devices 112 and/or any other device upon which the media guidance application is implemented.

In FIG. 1, the privacy settings and access permissions are different for entity 104 and entity 106. For example, entity 104 (e.g., a social network friend of user 104) is granted permission (e.g., as indicated by biometric measurements 108) to access the mood of user 102, but is denied permission to heart rate information. In contrast, entity 106 (e.g., a health care provider) is granted permission (e.g., as indicated by biometric measurements 110) to heart rate information and glucose information, but denied access to the mood of user 102.

In FIG. 1, the media guidance application has compared the entity identifier to the privacy settings to determine the access permissions associated with entity 104 and entity 106. In response to determining entity 104 has permission to access a first biometric measurement (e.g., mood) and does not have permission to access a second biometric measurement (e.g., heart rate information), the media guidance application shares the first biometric measurement of user 102 with entity 104 without sharing the second biometric measurement of user 102 with entity 104. In addition, in response to determining entity 106 has permission to access the second biometric measurement (e.g., heart rate information) and a third biometric measurement (e.g., glucose level information) and does not have permission to access the first biometric measurement (e.g., mood), the media guidance application shares the second and third biometric measurements of user 102 with entity 106 without sharing the first biometric measurement of user 102 with entity 106.

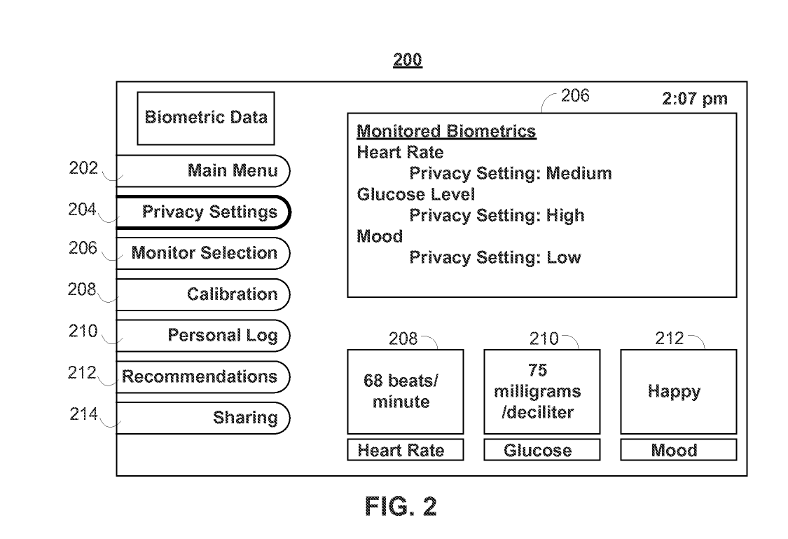

In some embodiments, as further discussed in relation to FIG. 2, the media guidance application may monitor the biometric measurements of user 102 in response to a user selection of biometric measurements to monitor. For example, the media guidance application may generate an interface (e.g., on one or more of user devices 112) through which a user may select which biometrics he/she wishes the media guidance application to monitor. For example, in diagram 100, via the media guidance application, user 102 may have chosen to allow the media guidance application to monitor the heart rate, glucose level, and mood, but refused to allow the media guidance application to monitor for other biometric measurements (e.g., perspiration, blood pressure, drowsiness, etc.) and/or other psychological (attention deficient disorder, anxiety level, etc.) or physiological conditions (e.g., heart disease, concentration levels, cancer, muscle disorders, etc.).

In some embodiments, based on the biometric measurements (e.g., biometric measurements 108 and 110), the media guidance application may receive a media asset targeted to the user. For example, in response to biometric measurements shared with an entity 106, entity 106 may transmit media (e.g., advertisements for glucose medications, reminders to take heart rate prescriptions, etc.) personalized based on the current biometric measurements and/or psychological or physiological conditions of user 102. Likewise, in response to biometric measurements shared with an entity 104, entity 104 may transmit media (e.g., friend requests, media content viewed by people in similar moods, etc.) personalized based on the current biometric measurements and/or psychological or physiological conditions of user 102.

FIG. 2 is a display associated with a media guidance application for use in selecting privacy settings associated with sharing biometric measurements of a user. Display 200 includes selectable options 202-214 each of which is associated with a feature of the media guidance application related to configuring privacy settings associated with the media guidance application, or accesses/navigating to the privacy settings (e.g., in the case of selectable option 202).

Selectable option 202 relates to returning to a main menu of the media guidance application. For example, display 200 may represent a sub-menu related to biometric data of a broader main menu. In some embodiments, the main menu may be accessed as part of a program guide featuring media guidance data for a plurality of media assets. In the program guide, the media listings may appear in a grid or as graphical images including cover art, still images from the content, video clip previews, live video from the content, or other types of content that indicate to a user the content being described by the media guidance data in the listing. Each of the graphical listings may also be accompanied by text to provide further information about the content associated with the listing.

The listings may appear in various sizes, but, if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, published Jun. 17, 2010, which is hereby incorporated by reference herein in its entirety.

In display 200, selectable option 204 is selected, thus providing listings video region 206, which displays the currently monitored biometrics and the privacy settings associated with each. For example, video region 206 indicates that the heart rate, glucose level, and mood of the user (e.g., user 102 (FIG. 1)) are currently being monitored. In addition, video region 206 indicates the privacy settings associated with each.

As discussed above, the privacy setting may indicate general rules related to the sharing of user information that are established, maintained, or agreed upon by the user. For example, the media guidance application may only share a biometric measurement associated with a “High” privacy setting with entities previously indicated by the user (e.g., via accepting a request from the entity to enter into a social network relationship associated with the user). The media guidance application may only share a biometric measurement associated with a “Medium” privacy setting with entities associated with a particular class of organizations with which the user has a previous relationship (e.g., health care providers of the user, business contacts of the user, employers of the user, etc.). The media guidance application may share a biometric measurement associated with a “Low” privacy setting with any entities (e.g., advertisers, content providers, etc.).

In some embodiments, the privacy setting may further define what access permissions that are granted for each entity. For example, in addition to, or as an alternative to the general privacy settings, display 200 may allow a user to enter specific entities that have access permissions to specific biometric measurements. Accordingly, the user may adjust his/her privacy settings such that a hospital is given access permissions to his/her heart rate data, but a government agency is not.

Selectable option 206 indicates the biometrics that are monitored by the media guidance application. For example, the media guidance application, or the user device upon which the media guidance application is implemented, may incorporate and/or have access to a plurality of sensors and/or monitoring components. In some embodiments, the media guidance application, or the user device upon which the media guidance application is implemented, may incorporate and/or have access to an electroencephalogram unit (“EEG”). An EEG measures electrical activity associated with a brain of a user. For example, an EEG may measure voltage fluctuations and/or the frequency or frequency range of voltage fluctuations generated by the brain of a user. In some embodiments, the media guidance application, or the user device upon which the media guidance application is implemented, may incorporate and/or have access to an electromyogram unit (“EMG”). An EMG measures the electrical activity of nerves controlling muscles at rest and during contraction.

In some embodiments, the media guidance application, or the user device upon which the media guidance application is implemented, may incorporate and/or have access to a heart monitor, glucose blood meter, respiratory monitors, devices for obtaining tissue, blood, and/or any other suitable samples from a user, and/or any other devices necessary for determining the biometric measurements of the user.

In some embodiments, display 200 may indicate psychological and/or physiological conditions to monitor in addition to, or as an alternative to, individual biometrics to monitor. For example, if the media guidance application monitors a mood of the user, the media guidance application may monitor multiple biometrics in order to monitor the mood. For example, the media guidance application may compare the breathing rate (e.g., determined via a respiratory monitor), blood pressure (e.g., via a blood pressure monitor), alpha wave activity (e.g., via a EKG), and muscle tension (e.g., via an EMG) to determine the particular mood a user is currently experiencing. Thus, in response to selecting to monitor a mood of the user, the media guidance application may obtain data from a plurality of devices and/or obtain a plurality of biometric measurements.

Selectable option 208 indicates a calibration feature. For example, the media guidance application may calibrate the various biometric measurements based on the typical measurement of the user and/or skewing caused by a particular sensor or monitoring component. For example, the media guidance application may track the biometrics of the user (e.g., in a personal log accessible via selectable option 210), which tracks various biometrics of the user (whether or not the biometrics are sharable to any entity).

Selectable option 212 relates to recommendations (e.g., for media content, products, services, etc.) that may be targeted to the user based on current biometric measurements. For example, in response to determining the user is in a sad mood, the media guidance application may recommend media content that is likely to enhance the mood of the user. In another example, selection selectable option 212 may provide the user with recommendations of other users that share the biometric measurements of the user. In yet another example, selecting selectable option 212 may provide the user with advertisements related to the current biometric measurements of the user. For example, the user may share his/her perspiration level with a content provider, in response to determining that the user has a high perspiration level, the media guidance application may present an advertisement for an antiperspirant.

Selectable option 214 relates to various methods and techniques for sharing biometric measurements. For example, the media guidance application may only share data with an entity when that entity is within a threshold proximity of the user. Using selectable option 214, a user may define the threshold proximity and/or any other suitable criteria related to sharing. For example, the media guidance application may determine a particular distance, a particular geographic area, a particular network(s), or any other set of criteria that prospective entities must meet in order for a request for biometric measurements to be considered by the media guidance application based on user inputs received via display 200.

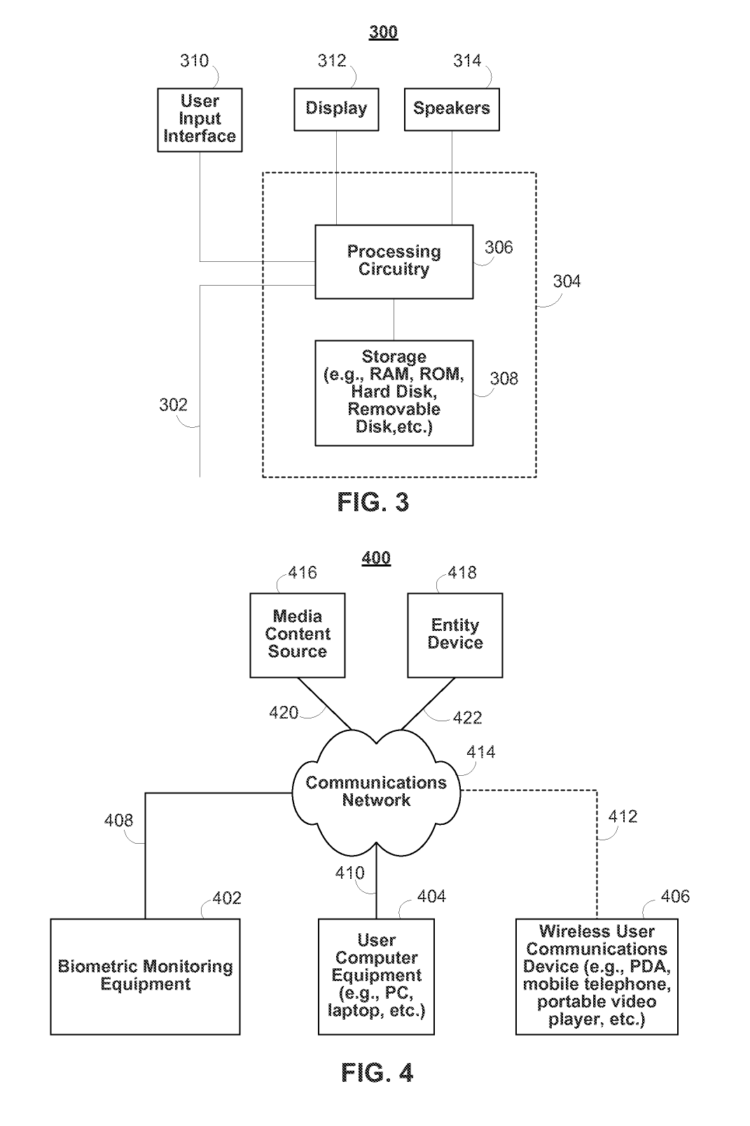

The media guidance application may obtain biometric measurements from a user and/or share those biometrics of the user with entities from one or more of their user equipment devices. FIG. 3 shows a generalized embodiment of illustrative user equipment device 300. More specific implementations of user equipment devices are discussed below in connection with FIG. 4. User equipment device 300 may receive content, biometric measurements and data via input/output (hereinafter “I/O”) path 302. I/O path 302 may provide content (e.g., broadcast programming, on-demand programming, Internet content, content available over a local area network (LAN) or wide area network (WAN), and/or other content), biometric measurements from one or more of the monitoring components discussed above, and any other data to control circuitry 304, which includes processing circuitry 306 and storage 308. Control circuitry 304 may be used to send and receive commands, requests, and other suitable data using I/O path 302. For example, I/O path 302 may be using transmit biometric measurements 108 (FIG. 1)). I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to obtain biometric measurements, compare privacy setting of a user to various entities, share biometric measurements with authorized entities, etc. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (e.g., to share biometric measurements) as described in more detail below.

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store biometric measurements, privacy settings, user profiles, and/or various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data and/or present targeted content to a user. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 (e.g., selections related to selectable options 202-214 (FIG. 2)) using user input interface 310. User input interface 310 may be any suitable user interface, such as a remote control, mouse, trackball, keypad, keyboard, touch screen, touchpad, stylus input, joystick, motion sensors, voice recognition interface, or other user input interfaces, including, but not limited to interfaces used to receive and/or monitor for one or more psychological or physiological conditions. For example, in some embodiments, user input interface 310 may functions as biometric monitoring equipment (e.g., as described below in relation to biometric monitoring equipment 402 (FIG. 4)). In such cases, active (e.g., via a remote control) or passive (e.g., via a heart rate monitor) user inputs received by user input interface 310 may indicate biometric measurements of the user.

Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as biometric monitoring equipment 402 (e.g., an EKG, EMG, blood pressure monitor, etc.), user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as biometric monitoring equipment 402, user computer equipment 404, or a wireless user communications device 406. For example, biometric monitoring equipment 402 may, like some user computer equipment 404, be Internet-enabled allowing for access to Internet content, while user computer equipment 404 may, like some biometric monitoring equipment 402, include sensors and/or monitoring component for obtain biometric measurements. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

The user may also set various settings (e.g., privacy settings as discussed in FIG. 2)) to maintain consistent media guidance application settings across in-home devices and remote devices. Settings include those described herein, user associations, group relationships, favorites, programming preferences that the guidance application utilizes to make monitoring decisions, programming recommendations, sharing recommendations, display preferences, and other desirable guidance settings. For example, if a user sets a privacy setting on, for example, the web site www.allrovi.com on their personal computer at their office, the same privacy setting would be used by the user's in-home devices (e.g., biometric monitoring equipment 402 and user computer equipment 404) as well as the user's mobile devices, if desired. Therefore, changes made on one user equipment device can change the privacy setting on another user equipment device, regardless of whether they are the same or a different type of user equipment device. In addition, the changes made may be based on settings input by a user (e.g., via selectable options 202-214 (FIG. 2)), as well as user activity monitored by the guidance application.

The user equipment devices may be coupled to communications network 414. Namely, biometric monitoring equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications between the media guidance application, entities requesting information, and/or the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and entity device 418 coupled to communications network 414 via communication paths 420 and 422, respectively. Paths 420 and 422 may include any of the communication paths described above in connection with paths 408, 410, and 412. Communications (e.g., the sharing of entity identifiers, biometric measurements, etc.) with the content source 416 and entity device 418 may be exchanged over one or more communications paths, but are shown as a single path in FIG. 4 to avoid overcomplicating the drawing. In addition, there may be more than one of each of content source 416 and entity device 418, but only one of each is shown in FIG. 4 to avoid overcomplicating the drawing. (The different types of each of these sources are discussed below.) If desired, content source 416 and entity device 418 may be integrated as one source device. Although communications between content source 416 and entity device 418 with user equipment devices 402, 404, and 406 are shown as through communications network 414, in some embodiments, content source 416 and entity device 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Entity device 418 may request biometric measurements of one or more users associated with one or more of user devices. Information may be shared between the devices using any suitable approach. For example, data may be shared via a data feed (e.g., a continuous feed or trickle feed).

In some embodiments, guidance data from entity device 418 may be provided to users' equipment using a client-server approach. For example, a user equipment device may pull requests for biometric measurements (e.g., in response to determining that an entity is within a threshold proximity) from a server (e.g., associated with an entity), or a server may push data to a user equipment device. In some embodiments, a guidance application client residing on the user's equipment may initiate sessions with entity device 418 to share data as requested, e.g., when the data at the entity device 418 is out of date (e.g., previously sent biometric measurement is no longer current) or when the user equipment device receives a request from the entity for data. Data may be provided to the user equipment with any suitable frequency (e.g., continuously, daily, a user-specified period of time, a system-specified period of time, in response to a request from user equipment, etc.).

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., entity device 418) running on control circuitry of the remote server. When executed by control circuitry of the remote server (such as entity device 418), the media guidance application may instruct the control circuitry to generate the guidance application displays and transmit the generated displays to the user equipment devices. The server application may instruct the control circuitry of the entity device 418 to transmit data for storage on the user equipment. The client application may instruct control circuitry of the receiving user equipment to generate the guidance application displays.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following three approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit biometric measurements obtained by each device.

In a second approach, users may have multiple types of user equipment by which they obtain biometric measurements. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various privacy settings on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more entity device 418. In addition or in the alternative, the remote computing sites may include other user equipment devices, such as biometric monitoring equipment 402, user computer equipment 404, and wireless user communications device 406. For example, the other user equipment devices may provide access to other biometric measurements not available using biometric monitoring equipment 402, user computer equipment 404, and wireless user communications device 406. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to obtain biometric measurements. The user can upload content to a content storage service on the cloud either directly, for example, from user computer equipment 404 or wireless user communications device 406 having content capture feature. This content may be analyzed to determine particular biometric measurements.

In some embodiments, the media guidance application may analyze captured audio or video data to determine a rate at which activities are/were being performed that may indicate a biometric measurement. For example, the media guidance application may access a content recognition module or algorithm to determine the objects in the received data (e.g., a captured video). The content recognition module may use object recognition techniques such as edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to determine the objects and/or relationship between the objects in received data in order to identify a user, determine whether or not a user is performing an activity, and if so, determine the rate the user is performing the activity, and/or any other data necessary to determine a biometric measurement.

For example, the media guidance application may receive data in the form of a video (e.g., captured via a content capture device at a location of the user). The video may include a series of frames. For each frame of the video, the media guidance application may use a content recognition module or algorithm to determine the object (e.g., an inhaling and exhaling chest of a user) in each of the frame or series of frames.

The media guidance application may then input the identified user and object into a database to determine an activity being performed. For example, if the media guidance application determines that the object (e.g., the chest of the user) is repeating an activity (e.g., inhaling and exhaling) the media guidance application may determine a biometric measurement (e.g., breathing rate) associated with that activity.

In some embodiments, the content recognition module or algorithm may also include speech recognition techniques, including, but not limited to, Hidden Markov Models, dynamic time warping, and/or neural networks (as described above) to translate spoken words into text and/or processing audio data. For example, by analyzing a voice pattern of the user, the media guidance application may determine if the user is out of breath (e.g., due to frequent interruptions in his/her speech due to heavy breathing), sleeping (e.g., due to detecting snoring), has a cold (e.g., due to a nasal overtone associated with the speech of the user), etc.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

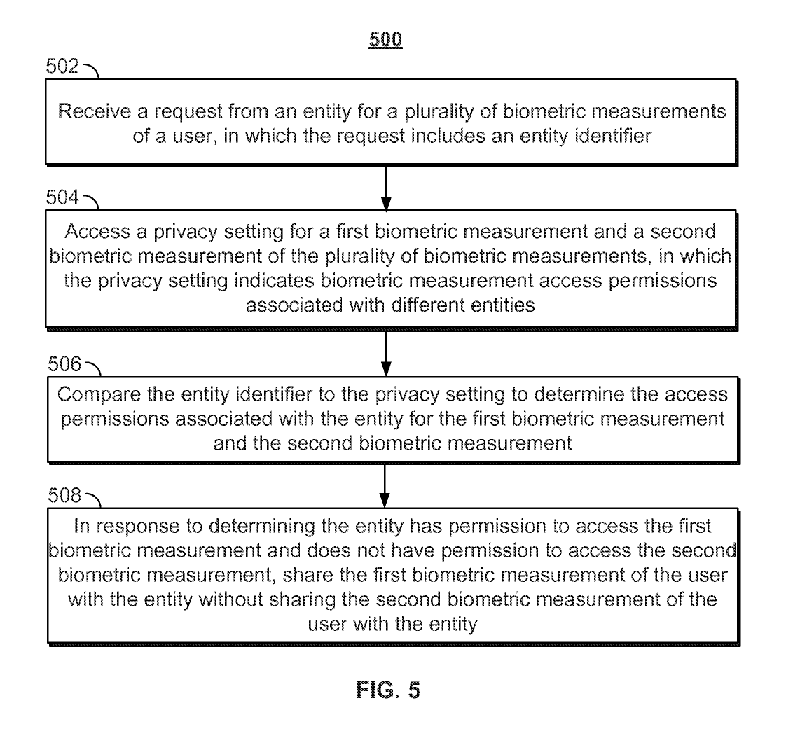

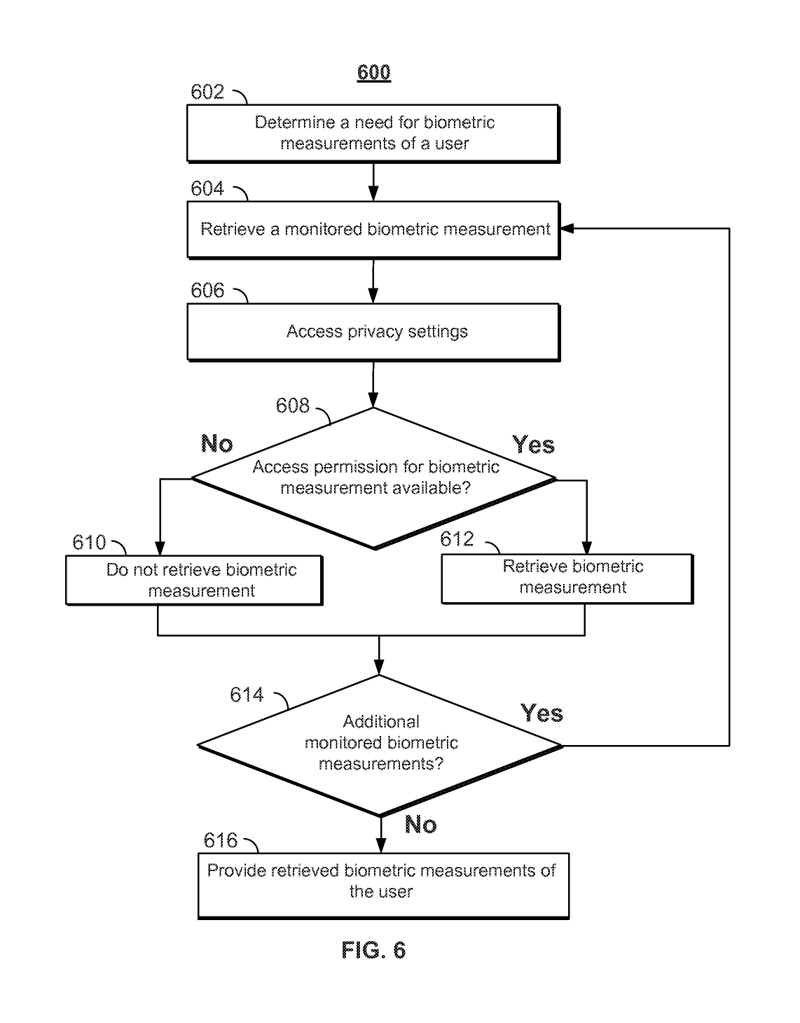

FIG. 5 is a flowchart of illustrative steps involved in sharing biometric measurements of a user based on privacy settings. It should be noted that process 500 or any step thereof could be performed on, or provided by, any of the devices shown in FIGS. 3-4. For example, process 500 may be executed by control circuitry 304 (FIG. 3) as instructed by a media guidance application implemented on user equipment 402, 404, and/or 406 (FIG. 4) in order to determine privacy settings associated with biometric measurements as described in diagram 100 (FIG. 1). In addition, one or more steps of process 500 may be incorporated into or combined with one or more steps of any other process or embodiment (e.g., process 600 (FIG. 6)).

At step 502, the media guidance application receives a request from an entity for a plurality of biometric measurements of a user, in which the request includes an entity identifier. For example, the media guidance application may receive (e.g., via I/O path 302 (FIG. 3)) requests for biometric measurements (e.g., biometric measurements 108 (FIG. 1)) of a user (e.g., user 102 (FIG. 1)) that an entity (e.g., entity 104 (FIG. 1)) may use for a variety of purposes. In some embodiments, the entity may wish to target content based on the biometric measurements of the user. For example, a coffee producer may wish to advertise its coffee products on a user device of a user when the user wakes up in the morning. Accordingly, the coffee producer may request biometric measurements (e.g., particular brain activity, frequency of eye motions, etc.) that indicate that a user is awake.

Furthermore, the entity may include an entity identifier in the request. For example, the media guidance application may detect (e.g., via control circuitry 304 (FIG. 3)) a serial number received with the request that identifies the entity requesting the biometric measurements. In another example, the entity may transmit a file, password, or any other data that is used by the media guidance application to verify the identity of the entity.

In some embodiments, the entity identifier may be transmitted simultaneously with the request and/or may be part of the request. Additionally or alternatively, the media guidance application may request an entity identifier from the entity in response to receiving a request, or in response to receiving a request for biometric measurements that are subject to a privacy setting.

At step 504, the media guidance application accesses a privacy setting for a first biometric measurement and a second biometric measurement of the plurality of biometric measurements, in which the privacy setting indicates biometric measurement access permissions associated with different entities. For example, the media guidance application may retrieve privacy settings associated with the biometric measurements of a user (e.g., user 102 (FIG. 1)) from a local storage (e.g., storage 308 (FIG. 3)) of a user device (e.g., user equipment device 402, 404, and/or 406 (FIG. 4)) upon which the media guidance application is implemented. Alternatively or additionally, the media guidance application may retrieve privacy settings from a remote location (e.g., any location accessible via communications network 414 (FIG. 4)).

At step 506, the media guidance application compares the entity identifier to the privacy setting to determine the access permissions associated with the entity for the first biometric measurement and the second biometric measurement. For example, the media guidance application may organize the privacy settings in a variety of organization schemes. In some embodiments, the media guidance application may use a database to store the various access permissions for each biometric measurement of the user that is granted for each entity. For example, in response to receiving a request (e.g., received via I/O path 302 (FIG. 3)), the media guidance application (e.g., via control circuitry 304 (FIG. 3)) may extract and/or determine an entity identifier associated with the request. The media guidance application may then cross-reference (e.g., via control circuitry 304 (FIG. 3)) the entity with a database (e.g., located at storage 308 (FIG. 3) or any location accessible via communications network 414 (FIG. 4)) that lists access permissions associated with various entities (or entity identifiers). The media guidance application (e.g., via control circuitry 304 (FIG. 3)), of the database itself, may filter the access permissions by the entity (or entity identifier) to determine all the access permissions associated with the entity.

For example, if the first biometric measurement is associated with one of the access permissions available to the entity after filtering the database, the media guidance application determines that the entity has permission to access the first biometric measurement. In contrast, if the second biometric measurement is not associated with one of the access permissions available to the entity after filtering the database, the media guidance application determines that the entity does not have permission to access the second biometric measurement.

At step 508, the media guidance application, in response to determining the entity has permission to access the first biometric measurement and does not have permission to access the second biometric measurement, shares the first biometric measurement of the user with the entity without sharing the second biometric measurement of the user with the entity. For example, the media guidance application (e.g., via control circuitry 304 (FIG. 3)) may transmit (e.g., along I/O path 302 (FIG. 3)) biometric measurements (e.g., biometric measurements 108 (FIG. 1)) that include the first biometric measurement of the user (e.g., user 102 (FIG. 1)) and does not include the second biometric measurement of the user.

In some embodiments, the media guidance application may then receive media content from the entity that is targeted to the user based on the shared biometric measurements. For example, in response to determining (e.g., based on one or more biometric measurements indicating an elevated heart rate and perspiration level) that a user (e.g., user 102 (FIG. 1)) is anxious, the entity may target an advertisement for anxiety medication or recommend media assets featuring soothing music.

In some embodiments, the media guidance application may not receive media content from the entity. For example, in response to determining (e.g., based on one or more biometric measurements indicating an elevated heart rate and perspiration level) that a user (e.g., user 102 (FIG. 1)) is anxious, the entity (e.g., a social network server) may generate an avatar associated with the user that indicates to other users of the social network that the user is currently feeling anxious.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in FIG. 5 in such alternative orders or in parallel.

FIG. 6 is a flowchart of illustrative steps involved in providing biometric measurements of a user based on privacy settings. It should be noted that process 600 or any step thereof could be performed on, or provided by, any of the devices shown in FIGS. 3-4. For example, process 600 may be executed by control circuitry 304 (FIG. 3) as instructed by a media guidance application implemented on user equipment 402, 404, and/or 406 (FIG. 4) in order to determine privacy settings associated with biometric measurements as described in diagram 100 (FIG. 1). In addition, one or more steps of process 600 may be incorporated into or combined with one or more steps of any other process or embodiment (e.g., process 500 (FIG. 5)).

At step 602, the media guidance application determines a need for biometric measurements of a user. For example, as discussed above in step 502, the media guidance application may receive (e.g., via I/O path 302 (FIG. 3)) requests for biometric measurements (e.g., biometric measurements 108 (FIG. 1)) of a user (e.g., user 102 (FIG. 1)) from an entity (e.g., entity 104 (FIG. 1)). Additionally or alternatively, the media guidance application itself may initiate the process. For example, in response to a user selection (e.g., via user input interface 310 (FIG. 3)) of an option (e.g., selectable option 212 (FIG. 2)) of a display (e.g., display 200 (FIG. 2)), the media guidance application may generate a recommendation of a media asset to a user based on the current biometric measurements that the user has selected should be monitored (e.g., the biometric measurements indicated in video region 206 (FIG. 2)).

In some embodiments, the media guidance application may generate a recommendation without first receiving a user selection (e.g., via user input interface 310 (FIG. 3)) to generate a recommendation. For example, the media guidance application may automatically generate a recommendation of a media asset in response to a user exceeding a particular threshold.

For example, in response to a user being within a threshold proximity of an entity (e.g., a department store), the media guidance application may process biometric measurements of the user in order to generate an advertisement (e.g., a coupon for the store) on a user device (e.g., user device 112 (FIG. 1)) associated with the user (e.g., user 102 (FIG. 1)). In another example, the media guidance application may continuously or periodically poll the monitored biometric measurements. For example, the media guidance application may poll the monitored biometric measurements to detect whether or not one or more biometric measurements (e.g., indicative of an emotional state) of the user correspond to one or more threshold biometric measurements (e.g., sadness) in order to perform an action (e.g., generate a media asset associated with making the user happy).

At step 604, the media guidance application retrieves a monitored biometric measurement. For example, the media guidance application (e.g., via control circuitry 304 (FIG. 3)) may obtain only some biometric measurements. In some cases, the media guidance application may not monitor for a biometric measurement due to a user selection (e.g., via selectable option 206 (FIG. 2)) not to obtain the biometric measurements. Additionally or alternatively, the media guidance application may not incorporate and/or have access to a monitoring device (e.g., biometric monitoring device 402 (FIG. 4)) capable of testing for a particular biometric measurement.

At step 606, the media guidance application accesses the privacy settings of the user related to monitored biometric measurements. In some embodiments, this step may correspond to step 504 (FIG. 5)). For example, the media guidance application may access privacy settings associated with the biometric measurements of a user (e.g., user 102 (FIG. 1)) located at local storage (e.g., storage 308 (FIG. 3)) of a user device (e.g., user equipment device 402, 404, and/or 406 (FIG. 4)) upon which the media guidance application is implemented. Alternatively or additionally, the media guidance application may access privacy settings for the user located at a remote location (e.g., any location accessible via communications network 414 (FIG. 4)).

At step 608, the media guidance application determines whether or not access permission for biometric measurements are available. For example, if an entity (e.g., entity 104 (FIG. 1)) is requesting biometric measurements, the media guidance application may determine whether or not to provide the biometric measurement based on whether or not the privacy settings associated with the entity grant the entity access permissions to the requested biometric measurements. In another example, if the media guidance application is requesting biometric measurements (e.g., in order to recommend a media asset to the user), the media guidance application may also determine whether or not to use the biometric measurement.

If the access permission for the biometric measurement is available, the media guidance application retrieves (e.g., from storage 308 (FIG. 3) and/or a remote location accessible via communications network 414 (FIG. 4)) the biometric measurement at step 612 before proceeding to step 614. If the access permission for the biometric measurement is not available, the media guidance application does not retrieve the biometric measurement at step 610 before proceeding to step 614.

In some embodiments, in response to determining the biometric measurement is not available (e.g., either due to a lack of access permission or the biometric measurement is not monitored for), the media guidance application may recommend/search for a similar and/or related biometric measurement. For example, in response to determining that heart rate information in not available, but blood pressure information is available, the media guidance application may recommend/search for the blood pressure information.

For example, the media guidance application may determine that although an entity (e.g., an advertiser, social network “friend,” content provider, etc.) has requested a first biometric measurement (e.g., “mood”), the privacy settings indicated that that entity does not have the necessary access permissions to receive the first biometric measurement. In response to determining that the entity does not have the proper access permissions for the first biometric measurement, the media guidance application may determine a second biometric measurement, similar to the first biometric measurement, which may be shared with the entity.

For example, in response to determining that an entity does not have an access permission to a first biometric measurement, the media guidance application (e.g., via control circuitry 304 (FIG. 3)) may reference a database (e.g., located at storage 308 (FIG. 3) or any location accessible via communications network 414 (FIG. 4)) associated with the biometric measurements that indicate relationships between the various biometric measurements. For example, the database may indicate particular groups of biometric measurements that are related (e.g., biometric measurements associated with the circulatory system of the user, digestive system of the user, mood of the user, likelihood of a user to perform a particular action, sociability of the user, etc.).

The media guidance application (e.g., via control circuitry 304 (FIG. 3)) may input the first biometric measurement into the database and receive an output of any biometric measurements that are similar to the first biometric measurement. In response to determining that the first biometric measurement is associated with other biometric measurements, the media guidance application (e.g., via control circuitry 304 (FIG. 3)) may determine whether or not any of the other biometric measurements may be shared by the entity. For example, for each of the other biometric measurements, the media guidance application may determine (e.g., via one or more steps of process 500 (FIG. 5)) whether or not the entity may receive one or more of the other biometric measurements. In response to determining that the entity does have the necessary access permissions for one or more of the other biometric measurements, the media guidance application (e.g., via control circuitry 304 (FIG. 3)) may share, or offer to share, the one or more of the other biometric measurements to the user. For example, the media guidance application may query the entity as to whether or not the entity would like to receive a different biometric measurement than the one that the entity requested.

At step 614, the media guidance application determines whether or not there are additional monitored biometric measurements. For example, the media guidance application may obtain biometric measurements from a plurality of biometric monitoring devices (e.g., biometric monitoring device 402 (FIG. 4)) or a single biometric monitoring device may obtain a plurality of biometric measurements.

In some embodiments, the media guidance application may determine a need for only some biometric measurements (e.g., the biometric measurements requested by an entity). Alternatively, the media guidance application may process all biometric measurements currently monitored (e.g., in response to a request for any biometric measurements associated with a user).

If the media guidance determines that there are additional monitored biometric measurements, the media guidance application returns to step 604. If the media guidance application determines that there are no additional monitored biometric measurements, the media guidance application provides the retrieved biometric measurements of the user. For example, if media guidance application retrieved the biometric measurements in response to a request from an entity, the media guidance application (e.g., via control circuitry 304 (FIG. 3)) may transmit (e.g., along I/O path 302 (FIG. 3)) biometric measurements (e.g., biometric measurements 108 (FIG. 1)) that includes the retrieved biometric measurement of the user (e.g., user 102 (FIG. 1)) to the entity (e.g., entity 104 (FIG. 1)). If media guidance application retrieved the biometric measurements in order to generate a media asset personalized for a user based on the biometric measurements of a user, the media guidance application (e.g., via control circuitry 304 (FIG. 3)) may process (e.g., via control circuitry 304 (FIG. 3)) the biometric measurements (e.g., biometric measurements 108 (FIG. 1)) to select a media asset.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in FIG. 6.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

What is claimed is:

1. A method for sharing psychological or physiological conditions of users, the method comprising:
receiving a request from an entity for a plurality of biometric measurements of a user, wherein the request includes an entity identifier;
accessing a privacy setting for a first biometric measurement and a second biometric measurement of the plurality of biometric measurements, wherein the privacy setting indicates biometric measurement access permissions associated with different entities;
comparing the entity identifier to the privacy setting to determine the access permissions associated with the entity for the first biometric measurement and the second biometric measurement; and
in response to determining the entity has permission to access the first biometric measurement and does not have permission to access the second biometric measurement, sharing the first biometric measurement of the user with the entity without sharing the second biometric measurement of the user with the entity.

2. The method of claim 1, further comprising monitoring the first biometric measurement of the user and the second biometric measurement of the user in response to a user selection to monitor the first biometric measurement and the second biometric measurement.

3. The method of claim 1, further comprising not monitoring a third biometric measurement of the user in response to a user selection to not monitor the third biometric measurement.

4. The method of claim 1, wherein the first biometric measurement relates to a current psychological or physiological condition of the user.

5. The method of claim 1, further comprising receiving a media asset targeted to the user based on the plurality of biometric measurements that have been shared with the entity.

6. The method of claim 1, wherein the entity is another user, and wherein the entity identifier indicates a social network relationship status of the another user relative to the user.

7. The method of claim 1, wherein sharing the first biometric measurement of the user further comprises transmitting a data packet indicative of the first biometric measurement of the user.

8. The method of claim 1, further comprising, in response to not sharing the second biometric measurement of the user with the entity, determining a third biometric measurement of the user, related to the second biometric measurement, for which access is permitted for the entity.

9. The method of claim 1, wherein the request is received when the user is within a threshold proximity to the entity.

10. The method of claim 1, wherein the first biometric measurement of the user relates to brain activity of the user.

11. A system for sharing psychological or physiological conditions of users, the system comprising control circuitry that:
receives a request from an entity for a plurality of biometric measurements of a user, wherein the request includes an entity identifier;
accesses a privacy setting for a first biometric measurement and a second biometric measurement of the plurality of biometric measurements, wherein the privacy setting indicates biometric measurement access permissions associated with different entities;
compares the entity identifier to the privacy setting to determine the access permissions associated with the entity for the first biometric measurement and the second biometric measurement; and
in response to determining the entity has permission to access the first biometric measurement and does not have permission to access the second biometric measurement, shares the first biometric measurement of the user with the entity without sharing the second biometric measurement of the user with the entity.

12. The system of claim 11, wherein the control circuitry monitors the first biometric measurement of the user and the second biometric measurement of the user in response to a user selection to monitor the first biometric measurement and the second biometric measurement.

13. The system of claim 11, wherein the control circuitry does not monitor a third biometric measurement of the user in response to a user selection to not monitor the third biometric measurement.

14. The system of claim 11, wherein the first biometric measurement relates to a current psychological or physiological condition of the user.

15. The system of claim 11, wherein the control circuitry receives a media asset targeted to the user based on the plurality of biometric measurements that have been shared with the entity.

16. The system of claim 11, wherein the entity is another user, and wherein the entity identifier indicates a social network relationship status of the another user relative to the user.

17. The system of claim 11, wherein the control circuitry shares the first biometric measurement of the user by transmitting a data packet indicative of the first biometric measurement of the user.

18. The system of claim 11, wherein the control circuitry, in response to not sharing the second biometric measurement of the user with the entity, determines a third biometric measurement of the user, related to the second biometric measurement, for which access is permitted for the entity.

19. The system of claim 11, wherein the request is received when the user is within a threshold proximity to the entity.

20. The system of claim 11, wherein the first biometric measurement of the user relates to brain activity of the user.

21. A method for sharing psychological or physiological conditions of users between devices, the method comprising:
receiving a request from a first device associated with an entity for a plurality of biometric measurements of a user, wherein the request includes an entity identifier;
accessing a privacy setting on a second device associated with the user for a first biometric measurement and a second biometric measurement of the plurality of biometric measurements, wherein the privacy setting indicates biometric measurement access permissions associated with different entities;
comparing the entity identifier to the privacy setting to determine the access permissions associated with the entity for the first biometric measurement and the second biometric measurement; and
in response to determining the entity has permission to access the first biometric measurement and does not have permission to access the second biometric measurement, sharing the first biometric measurement of the user with the entity without sharing the second biometric measurement of the user with the entity.

22. The method of claim 21, further comprising monitoring the first biometric measurement of the user and the second biometric measurement of the user in response to a user selection to monitor the first biometric measurement and the second biometric measurement.

23. The method of any one of claim 21 or 22, further comprising not monitoring a third biometric measurement of the user in response to a user selection to not monitor the third biometric measurement.

24. The method of any one of claims 21-23, wherein the first biometric measurement relates to a current psychological or physiological condition of the user.

25. The method of any one of claims 21-24, further comprising receiving a media asset targeted to the user based on the plurality of biometric measurements that have been shared with the entity.

26. The method of any one of claims 21-25, wherein the entity is another user, and wherein the entity identifier indicates a social network relationship status of the another user relative to the user.

27. The method of any one of claims 21-26, wherein sharing the first biometric measurement of the user further comprises transmitting a data packet indicative of the first biometric measurement of the user.

28. The method of any one of claims 21-27, further comprising in response to not sharing the second biometric measurement of the user with the entity, determining a third biometric measurement of the user, related to the second biometric measurement, for which access is permitted for the entity.

29. The method of any one of claims 21-28, wherein the request is received when the user is within a threshold proximity to the entity.

30. The method of any one of claims 21-29, wherein the first biometric measurement of the user relates to brain activity of the user.

31. A system for sharing psychological or physiological conditions of users, the system comprising:
means for receiving a request from an entity for a plurality of biometric measurements of a user, wherein the request includes an entity identifier;
means for accessing a privacy setting for a first biometric measurement and a second biometric measurement of the plurality of biometric measurements, wherein the privacy setting indicates biometric measurement access permissions associated with different entities;
means for comparing the entity identifier to the privacy setting to determine the access permissions associated with the entity for the first biometric measurement and the second biometric measurement; and
in response to determining the entity has permission to access the first biometric measurement and does not have permission to access the second biometric measurement, means for sharing the first biometric measurement of the user with the entity without sharing the second biometric measurement of the user with the entity.

32. The system of claim 31, further comprising means for monitoring the first biometric measurement of the user and the second biometric measurement of the user in response to a user selection to monitor the first biometric measurement and the second biometric measurement.

33. The system of claim 31, further comprising means for selecting not to monitor a third biometric measurement of the user.

34. The system of claim 31, wherein the first biometric measurement relates to a current psychological or physiological condition of the user.

35. The system of claim 31, further comprising means for receiving a media asset targeted to the user based on the plurality of biometric measurements that have been shared with the entity.

36. The system of claim 31, wherein the entity is another user, and wherein the entity identifier indicates a social network relationship status of the another user relative to the user.

37. The system of claim 31, wherein the means for sharing the first biometric measurement of the user further comprises means for transmitting a data packet indicative of the first biometric measurement of the user.

38. The system of claim 31, further comprising in response to not sharing the second biometric measurement of the user with the entity, means for determining a third biometric measurement of the user, related to the second biometric measurement, for which access is permitted for the entity.

39. The system of claim 31, wherein the request is received when the user is within a threshold proximity to the entity.

40. The system of claim 31, wherein the first biometric measurement of the user relates to brain activity of the user.

41. Non-transitory computer readable storage media comprising machine readable instructions for:
receiving a request from an entity for a plurality of biometric measurements of a user, wherein the request includes an entity identifier;
accessing a privacy setting for a first biometric measurement and a second biometric measurement of the plurality of biometric measurements, wherein the privacy setting indicates biometric measurement access permissions associated with different entities;
comparing the entity identifier to the privacy setting to determine the access permissions associated with the entity for the first biometric measurement and the second biometric measurement; and
in response to determining the entity has permission to access the first biometric measurement and does not have permission to access the second biometric measurement, sharing the first biometric measurement of the user with the entity without sharing the second biometric measurement of the user with the entity.

42. The non-transitory computer readable storage media of claim 41, further comprising machine readable instructions for monitoring the first biometric measurement of the user and the second biometric measurement of the user in response to a user selection to monitor the first biometric measurement and the second biometric measurement.

43. The non-transitory computer readable storage media of claim 41, further comprising machine readable instructions for not monitoring a third biometric measurement of the user in response to a user selection to not monitor the third biometric measurement.

44. The non-transitory computer readable storage media of claim 41, wherein the first biometric measurement relates to a current psychological or physiological condition of the user.

45. The non-transitory computer readable storage media of claim 41, further comprising machine readable instructions for receiving a media asset, and wherein the media asset is targeted to the user based on the plurality of biometric measurements that have been shared with the entity.

46. The non-transitory computer readable storage media of claim 41, wherein the entity is another user, and wherein the entity identifier indicates a social network relationship status of the another user relative to the user.

47. The non-transitory computer readable storage media of claim 41, wherein the machine readable instructions for sharing the first biometric measurement of the user further comprises machine readable instructions for transmitting a data packet indicative of the first biometric measurement of the user.

48. The non-transitory computer readable storage media of claim 41, further comprising machine readable instructions for, in response to not sharing the second biometric measurement of the user with the entity, determining a third biometric measurement of the user, related to the second biometric measurement, for which access is permitted for the entity.

49. The non-transitory computer readable storage media of claim 41, wherein the request is received when the user is within a threshold proximity to the entity.

50. The non-transitory computer readable storage media of claim 41, wherein the first biometric measurement of the user relates to brain activity of the user.
